(19) United States
(12) Patent Application Publication
(10) Pub. No.: US 2025/0018522 A1
(43) Pub. Date: Jan. 16, 2025

(54) SYSTEMS AND METHODS FOR MECHANICAL POLISHING

(71) Applicant: SYBRIDGE TECHNOLOGIES U.S. INC., Southfield, MI (US)

(72) Inventors: J. Louie MENESES, Windsor (CA); Davide MARTINO, Tecumseh (CA)

(21) Appl. No.: 18/708,964

(22) PCT Filed: Nov. 10, 2022
(86) PCT No.: PCT/US2022/049536

§ 371 Date: May 9, 2024

Related U.S. Application Data
(60) Provisional application No. 62/278,017, filed on Jan. 13, 2016.

(51) Int. Cl. B24B 37/013; B25J 9/16; B25J 11/00; B25J 15/00

(52) U.S. Cl. CPC B24B 37/013; B25J 9/1682; B25J 9/1697; B25J 11/0065; B25J 15/0019

(57) ABSTRACT

Systems and methods for mechanical polishing are disclosed. A verification apparatus may obtain a surface finish indicator associated with a surface to be polished, for example a manufacturing mold. A controller may be configured to receive, from the verification apparatus, the surface finish indicator. The controller may be configured to obtain a reference polishing profile for the surface. The controller may be configured to send, to a polishing apparatus, a command to perform a mechanical polishing function on the surface based on the obtained surface finish indicator, and optionally also based on the reference polishing profile. A polishing apparatus, such as one or more polishing robots, may perform the mechanical polishing function on the surface. Implementations may provide increased production speed, reduced repetitive injuries, and automated polishing, in a way that is less labor intensive and reduces dependence on highly skilled labor.

### CROSS-REFERENCE TO RELATED APPLICATIONS

This application claims the benefit of priority of U.S. patent application Ser. No. 63/278,017, filed Nov. 10, 2021, which is hereby incorporated by reference.

### FIELD

The present disclosure relates to polishing, including but not limited to systems, computing platforms, methods, and storage media for performing automated mechanical polishing.

### BACKGROUND

Mechanical polishing is desirable with respect to manufacturing molds, such as plastic injection molds. Polishing is used to give plastic parts a desired esthetic look, as well as to help the parts more easily eject from the mold. In contrast to buffing, polishing typically removes a certain amount of material at a microscopic level, for example by flattening microscopic grooves introduced by a cutter. Polishing may be performed using a hand-held pneumatic device, stone, paper, or other polishing means.

The desired appearance of the part typically dictates the level of polishing required on the mold. For example, a painted part may need one level of polishing, while a chrome-plated part typically needs a higher level of polishing. A lens part, for example a lens on a vehicle headlight, typically needs an even higher level of polishing than a chrome-plated part.

The polishing process is typically very labor intensive. There can be health and safety concerns due to repetitive motion for people performing the polishing for a prolonged period of time. There is also a shortage of skilled polishers. Companies often need to outsource polishing due to time and resource constraints.

Improvements in approaches for performing mechanical polishing are desirable.

### SUMMARY

One aspect of the present disclosure relates to a system for mechanical polishing of a surface of a manufacturing mold. The system may include a verification apparatus configured to obtain a surface finish indicator associated with the surface of the manufacturing mold to be polished. The system may include a polishing robot configured to perform a mechanical polishing function on the surface, the mechanical polishing function removing material from the surface. The system may include a controller configured to: receive, from the verification apparatus, the surface finish indicator, obtain a reference polishing profile for the surface, and send, to the polishing robot, a command to perform the polishing function on the surface based on the obtained surface finish indicator and the reference polishing profile.

Another aspect of the present disclosure relates to a method for mechanical polishing of a surface of a manufacturing mold. The method may comprise: obtaining, by a verification apparatus, a surface finish indicator associated with the surface of the manufacturing mold to be polished; receiving, by a controller and from the verification apparatus, the surface finish indicator; obtaining, by the controller, a reference polishing profile for the surface; sending, by the controller and to a polishing robot, a command to perform a mechanical polishing function on the surface based on the obtained surface finish indicator and the reference polishing profile; and performing, by the polishing robot, the mechanical polishing function on the surface, the mechanical polishing function removing material from the surface. In an example embodiment, the present disclosure provides a non-transient computer-readable storage medium having instructions embodied thereon. The instructions may be executable by one or more processors to perform a method of mechanical polishing as described and illustrated herein.

### BRIEF DESCRIPTION OF THE DRAWINGS

Embodiments of the present disclosure will now be described, by way of example only, with reference to the attached Figures.

FIG. 1 illustrates a block diagram of a system for mechanical polishing, in accordance with one or more embodiments.

FIG. 2 illustrates a system for mechanical polishing, in accordance with one or more embodiments.

FIG. 3 illustrates another system for mechanical polishing, in accordance with one or more embodiments.

FIG. 4 illustrates an example of an end effector for a robotic polisher, in accordance with one or more embodiments.

FIG. 5 illustrates a further system for mechanical polishing, in accordance with one or more embodiments.

FIG. 6 illustrates a method for mechanical polishing, in accordance with one or more embodiments.

### DETAILED DESCRIPTION

Systems and methods for mechanical polishing are disclosed. A verification apparatus may obtain a surface finish indicator associated with a surface to be polished, for example a surface of a manufacturing mold. A controller may be configured to receive, from the verification apparatus, the surface finish indicator. The controller may be configured to obtain a reference polishing profile for the surface. The controller may be configured to send, to a polishing apparatus, a command to perform a mechanical polishing function on the surface based on the obtained surface finish indicator, and optionally also based on the reference polishing profile. A polishing apparatus, such as one or more polishing robots, may perform the mechanical polishing function on the surface.

Compared to known approaches, embodiments of the present disclosure may provide increased production speed, reduced repetitive injuries, and automated polishing, in a way that is less labor intensive and reduces dependence on highly skilled labor.

Embodiments of the present disclosure relate to polishing surfaces, such as a surface of a manufacturing mold. The system may include a verification apparatus, or quality checking system, and a polishing apparatus, or polishing setup. The verification apparatus may comprise, or operate in conjunction with, a vision system, metrology or metallurgy to verify the quality of the polished surface. The polishing apparatus may comprise one or more of robots, lasers, machines or collaborative robot (co-bot) to polish the surface.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

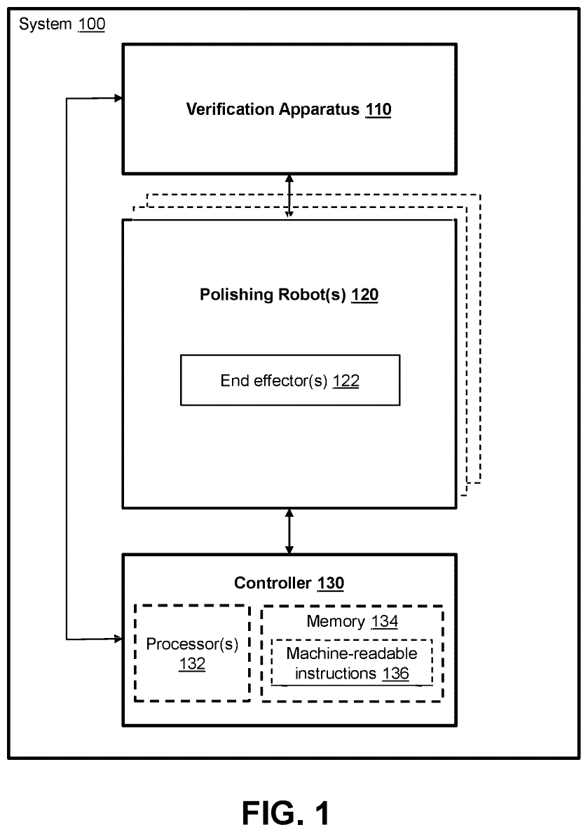

FIG. 1 illustrates a block diagram of a system 100 for mechanical polishing, in accordance with one or more embodiments. In an embodiment, the system 100 comprises a system for mechanical polishing of a surface, such as a surface of a manufacturing mold. The system 100 may include a verification apparatus 110 configured to obtain a surface finish indicator associated with the surface of the manufacturing mold to be polished. In one example embodiment, the verification apparatus 110 comprises a vision system including at least one camera, and the polishing indicator comprises an image of the surface. In another example embodiment, the verification apparatus 110 comprises a sensor, and the surface finish indicator comprises data associated with a measured finish quality of the surface, for example a sensed roughness value, surface thickness, etc.

The system 100 may include a polishing apparatus, such as a polishing robot 120, configured to perform a mechanical polishing function on the surface, where the mechanical polishing function removes material from the surface, as opposed to buffing. In embodiments to be described in more detail later, one or more polishing robots 120 may be provided. In an embodiment, the polishing robot(s) 120 include an end effector 122 configured to manipulate a polishing tool, for example where the polishing tool is used to perform the polishing function on the surface.

The system 100 may include a controller 130, which may be in communication with the verification apparatus 110 and with the polishing robot(s) 120. In an embodiment, the controller 130 comprises one or more processors 132 and a memory 134, such as or one or more machine-readable memories, storing machine-readable instructions 136 for execution by the processor(s) 132 to operate the system 100 and/or to implement a method of mechanical polishing using the system 100.

The controller 130 may be configured to receive, from the verification apparatus 110, the surface finish indicator. The controller 130 may be configured to obtain a reference polishing profile for the surface, for example based on data associated with the manufacturing mold being polished or with the specific surface being polished. The reference polishing profile may be obtained from the memory 134 or from another computer-readable medium, such as a database, associated with the controller 130 or with the polishing robot(s) 120 or with the verification apparatus 110. Such a computer-readable medium may be provided at the system 100 or in communication with the system 100. In an example embodiment, the surface may have associated therewith a quick response (QR) code which, when scanned, enables the controller 130 to obtain the reference polishing profile, for example by directing the controller 130 to the location of the profile. The controller 130 may cooperate with the verification apparatus 110, and for example a camera or vision system within the verification apparatus 110, to scan the QR code.

The controller 130 may be configured to send, to the polishing robot 120, a command to perform the polishing function on the surface based on the obtained surface finish indicator and on the reference polishing profile. The controller 130 may be configured send the command based on a comparison between the obtained surface finish indicator and the reference polishing profile. In an example embodiment, the controller 130 is configured to: compare, using a machine learning-based comparator, the obtained surface finish indicator with the reference polishing profile, and to generate the command based at least in part on a result of the comparison using the machine learning-based comparator. The machine learning-based comparator may be based on artificial intelligence and machine learning optimizations.

Since the controller 130 may be configured to send a command to perform the polishing function based on the obtained surface finish indicator and on the reference polishing profile, the same system 100 may be configured to polish any number of different surfaces. For example, the system 100 may be configured to polish a plurality of different surfaces of a plurality of different mechanical molds, based on each mold having a different reference polishing profile. Accordingly, the system 100 is flexible and adaptable to polish any number of different molds, such as a plastic injection mold, a die cast mold or any mold that requires mechanical polishing, such as metal polishing. This is in contrast to some known polishing apparatuses that may be configured to polish one specific mold.

In an embodiment, the controller 130 is configured to cooperate with the verification apparatus 110 to determine a surface finish level based on the obtained data associated with the measured finish quality of the surface.

The system 100 may be configured to perform the polishing function on the surface in accordance with different types of finishes. Table 1 below provides an example description of different types of finishes. The system 100 may be configured to send a command to perform the polishing function on the surface based on a finish characteristic, where the finish characteristic is based on one or more elements in

Table 1, or characteristics similar to the elements of Table 1. The finish characteristic may be part of the reference polishing profile.

TABLE 1

| Type of | Current SPI Finish | | | |
|---|---|---|---|---|
| Finish | Numbers | | Description | Ra, μm |
| Diamond | #3 Diamond Buff | A1 | Lens/Mirror | 0.025 |
| | #6 Diamond Buff | A2 | High Polish | 0.05 |
| | #15 Diamond Buff | A3 | High Polish | 0.1 |
| Paper | 600 Grit | B1 | Medium Polish | 0.2 |
| | 400 Grit | B2 | Medium Polish | 0.4 |
| | 320 Grit | B3 | Medium-Low Polish | 0.8 |
| Stone | 600 Stone | C1 | Low Polish | 1.6 |
| | 400 Stone | C2 | Low Polish | 3.2 |
| | 320 Stone | C3 | Low Polish | 6.3 |

In an example embodiment, to achieve a higher finish characteristic, it is necessary to progress through each of the finish characteristics. For example, before attempting to achieve an SPI (Society of Plastics Industry) finish number of B3, it is necessary to have sequentially achieved each of finish characteristics C3, C2 and then C1. A system 100 and controller 130 according to embodiments of the present disclosure are configured to provide instructions accordingly, such that an indication to achieve an SPI finish number of B3 is interpreted as a nested set of instructions. The nested set of instructions may include instructions to sequentially achieve finish characteristics associated with each of finish numbers C3, C2 and C1, and then B3, to the extent that the obtained surface finish indicator reveals that the surface has not already achieved these levels.

In an example embodiment, the controller 130 is configured to send the command to perform the polishing function based on a specified surface finish parameter. In such an example embodiment, the polishing robot is configured to perform the polishing function on the surface such that, after the polishing function has been completed, the surface complies with the specified surface finish parameter.

In an example embodiment, the specified surface finish parameter comprises a type of finish selected from the group consisting of a stone finish, a paper finish and a diamond finish.

In an example embodiment, the specified surface finish parameter comprises a low polish with a roughness average (Ra) of about 1.6 micrometers to about 6.3 micrometers. In an example embodiment, the specified surface finish parameter comprises a medium polish with a roughness average (Ra) of about 0.2 micrometers to about 0.8 micrometers. In an example embodiment, the specified surface finish parameter comprises a high polish with a roughness average (Ra) of about 0.1 micrometers to about 0.05 micrometers. In an example embodiment, the specified surface finish parameter comprises a lens or mirror polish with a roughness average (Ra) of about 0.05 micrometers.

In an example embodiment, the specified surface finish parameter comprises an SPI finish number selected from the group consisting of: 320 Stone C3, 400 Stone C2, 600 Stone C1, 320 Grit B3, 400 Grit B2, 600 Grit B1, #15 Diamond Buff A3, #6 Diamond Buff A2, and #3 Diamond Buff A1.

In an embodiment, the verification apparatus 110 may be configured to cooperate with the controller 130 to provide feedback on one or more of: a current polishing state; a current location; or a current orientation. The current location or current orientation may be with reference to the polishing robot 120 or the verification apparatus 110. The polishing robot 120 may also be configured to provide feedback on one or more of the current polishing state or on the current location or the current orientation. The controller 130 may be configured to send, to the polishing robot 120, a subsequent command to perform a remaining portion of the polishing function, for example based on one or more of the current polishing state or on the current location or the current orientation. For example, the controller 130 may send a subsequent command to the polishing robot 120 to move to a different orientation to perform the remaining portion of the polishing function, for example to change the orientation by 45 degrees, and then possibly to move to a different location.

In another embodiment, the system 100 may not itself include a polishing apparatus/robot, but may be in communication with the polishing apparatus/robot to instruct the polishing apparatus/robot to perform the mechanical polishing. In such an embodiment, the system for mechanical polishing of a surface of a manufacturing mold may comprise: a verification apparatus configured to obtain a surface finish indicator associated with the surface of the manufacturing mold to be polished; and a controller configured to: receive, from the verification apparatus, the surface finish indicator, obtain a reference polishing profile for the surface, and send, to a polishing robot, a command to perform a mechanical polishing function on the surface based on the obtained surface finish indicator and the reference polishing profile, the mechanical polishing function configured to remove material from the surface.

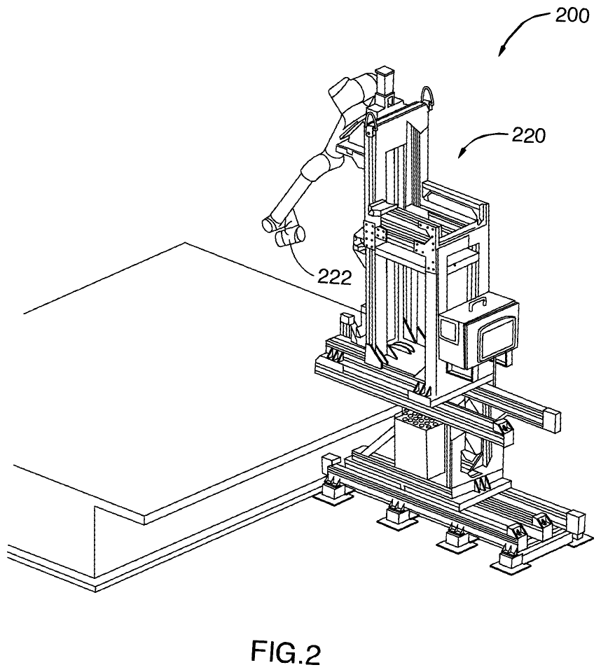

FIG. 2 illustrates a system 200 for mechanical polishing, in accordance with one or more embodiments. The system 200 may comprise, or be in communication with, a polishing robot 220. The system 200 shows an example embodiment in which a polishing robot 220 includes an end effector 222, similar to the polishing robot 120 which includes end effector 122 in FIG. 1.

The polishing robot 220 of FIG. 2 may be configured to perform a polishing function that can include multiple commands of staged polishing to achieve a desired end result, such as described above. For example, the controller (shown in FIG. 1, but not shown in FIG. 2) may be configured to send first and second commands to perform first and second polishing functions based on a first surface finish parameter and a second surface finish parameter, respectively. The second surface finish parameter may be associated with a higher polish than the first surface finish parameter. The polishing robot 220 may be configured to perform the first polishing function such that, after the first polishing function has been completed, the surface complies with the first surface finish parameter. The polishing robot 220 may also be configured to subsequently perform the second polishing function such that, after the second polishing function has been completed, the surface complies with the second surface finish parameter. In an example embodiment, this process is repeated for a plurality of polishing functions as needed to achieve the desired surface finish parameter.

In an example embodiment, the controller is configured to receive a first polishing completion indication from the polishing robot upon completion of the first polishing function. In this example embodiment, the controller is also configured to prevent the polishing robot from performing the second polishing function until the first polishing completion indication has been received. Accordingly, the system 200 is configured to ensure that the polishing robot 220 completes the first polishing function before performing the second polishing function.

In another embodiment, the system 200 is configured to define two different areas in relation to which the polishing robot 220 is configured to perform two different polishing functions. This can be useful, for example, in a situation where a higher polish is desired on one part of the surface, and a lower polish is desired on another part of the surface. In an example embodiment, the system 200 comprises a verification apparatus as well as the polishing robot 220 and a controller. The verification apparatus may be configured to obtain first and second surface finish indicators providing respective indications of a measured finish quality of first and second areas of the surface to be polished. The polishing robot may be configured to perform first and second polishing functions on the first and second areas of the surface, respectively. The controller may be configured to receive, from the verification apparatus, the first and second surface finish indicators. The controller may be configured to send, to the polishing robot, a first command to perform the first polishing function on the first area of the surface based on the first surface finish indicator. The controller may be configured to send, to the polishing robot, a second command to perform the second polishing function on the second area of the surface based on the second surface finish indicator.

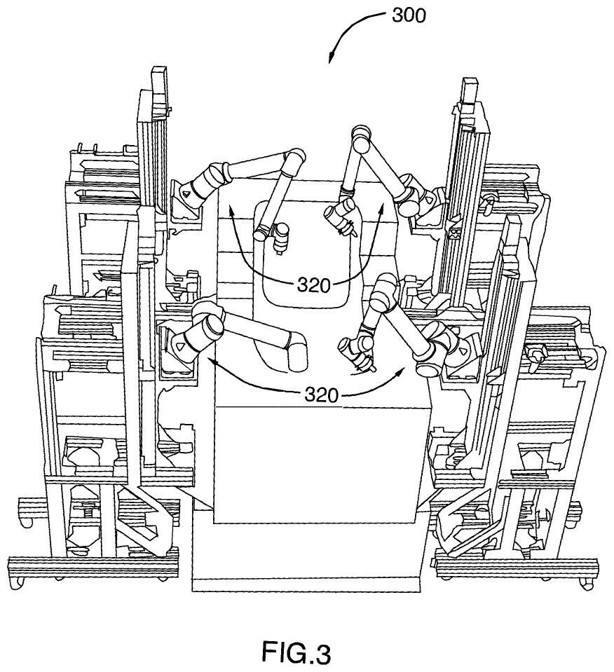

FIG. 3 illustrates another system 300 for mechanical polishing, in accordance with one or more embodiments. The system may comprise, or be in communication with, a plurality of polishing robots. In the example embodiment of FIG. 3, the system 300 comprises, or is in communication with, four polishing robots 320. In an example embodiment, the system 300 comprises a verification apparatus and a controller. In an embodiment, the system 300 comprises a separate verification apparatus associated with each of the plurality of polishing robots, to enable customized verification for each polishing robot. In one embodiment, the system 300 comprises a separate verification apparatus and a separate controller for each of the plurality of polishing robots. In another embodiment, the system 300 comprises one or more controllers configured to control the plurality of polishing robots 320.

In an example embodiment, the system 300 is configured to instruct the plurality of robots to cooperate to perform polishing functions according to the same surface finish indicator. The plurality of polishing robots 320 may be configured to perform a plurality of polishing functions on the surface. The controller may be configured to receive, from the verification apparatus, the surface finish indicator. The controller may be configured to send, to the plurality of polishing robots 320, a plurality of commands to cooperate to perform the plurality of polishing functions on the surface based on the surface finish indicator.

In an example embodiment, the system 300 is configured to specify or to define a plurality of areas and a plurality of commands for the plurality of robots to perform a plurality of polishing functions, where one or more of the polishing functions are different from the others. The verification apparatus may be configured to obtain a plurality of surface finish indicators providing respective indications of a measured finish quality of a plurality of areas of the surface to be polished. The plurality of polishing robots may be configured to perform a plurality of polishing functions on the plurality of areas of the surface. The controller may be configured to receive, from the verification apparatus, the plurality of surface finish indicators. The controller may be configured to send, to the plurality of polishing robots, a plurality of commands to perform the plurality of polishing functions on the plurality of areas of the surface based on the plurality of surface finish indicators.

In an example embodiment, the system 300 is configured to instruct different robots to substantially concurrently polish the same area. For example, the plurality of polishing robots 320 may comprise a first set of polishing robots and a second set of polishing robots. In an example embodiment, the first set of polishing robots comprises the two polishing robots on the left of the mold in FIG. 3, and the second set of polishing robots comprises the two polishing robots on the right of the mold in FIG. 3. The first and second sets of polishing robots may be configured to substantially concurrently perform first and second polishing functions, respectively, on the same area of the surface. The controller may be configured to send, to the first and second sets of polishing robots, first and second sets of commands to perform the first and second functions, respectively, on the same area of the surface.

In an example embodiment, the system 300 is configured to instruct different robots to substantially sequentially polish the same area. For example, the plurality of polishing robots may comprise a first set of polishing robots and a second set of polishing robots. The first and second sets of polishing robots may be configured to perform first and second polishing functions substantially sequentially on the same area of the surface. For example, the second set of polishing robots may be configured to perform the second polishing function after the first set of polishing robots has completed performing the first polishing function. The controller may be configured to send, to the first and second sets of polishing robots, first and second sets of commands to perform the first and second functions, respectively, on the same area of the surface.

In an example embodiment, the system 300 is configured to instruct different robots to substantially concurrently polish different areas. The plurality of polishing robots may comprise a first set of polishing robots and a second set of polishing robots. The first and second sets of polishing robots may be configured to substantially concurrently perform first and second polishing functions on first and second areas of the surface, respectively. The controller may be configured to send, to the first and second sets of polishing robots, first and second sets of commands to perform the first and second functions, respectively, on the first and second areas of the surface. In an example embodiment, the first set of polishing robots comprises the two polishing robots on the left of the mold in FIG. 3 configured to polish a left side of the surface, and the second set of polishing robots comprises the two polishing robots on the right of the mold in FIG. 3 configured to polish a right side of the surface.

In an example embodiment, the system 300 is configured to instruct different robots to substantially sequentially polish different areas. The plurality of polishing robots may comprise a first set of polishing robots and a second set of polishing robots. The first and second sets of polishing robots may be configured to perform first and second polishing functions substantially sequentially on first and second areas of the surface. The controller may be configured to send, to the first and second sets of polishing robots, first and second sets of commands to perform the first and second functions, respectively, on the first and second areas of the surface.

In an example embodiment, the system 300 may further comprise a set of rails on which the polishing robots may travel.

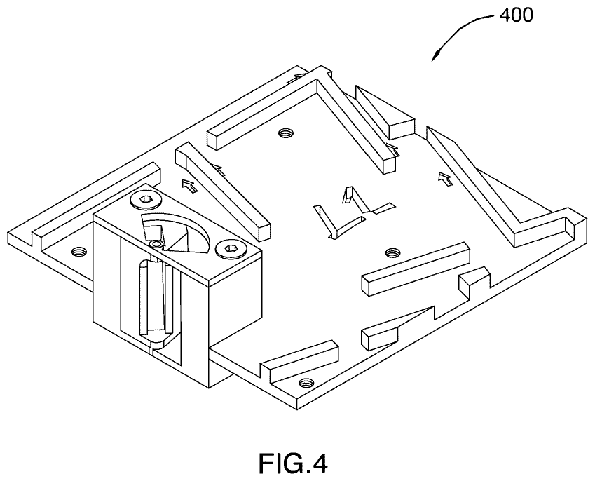

FIG. 4 illustrates an example of a stone holder 400 for use with an end effector for a robotic polisher, in accordance with one or more embodiments. A system according to an embodiment may use precut stones for the polishing process, and may use a stone cutting jib to shape the stones. The system may use 3D printed holders, which are rigid or flexible, for holding the polishing stones. As shown in FIG. 1, a robotic polisher 120 may include an end effector 122 configured to manipulate a polishing tool, for example where the polishing tool is used to perform the polishing function. The end effector may comprise a stone holder configured to manipulate a polishing stone to perform the polishing function on the surface. FIG. 4 illustrates an example of a stone holder 400 according to one or more embodiments.

In an embodiment, the stone holder 400 is a rigid stone holder used for complex geometries. For example, the stone holder 400 may comprise a rigid stone holder configured to manipulate one of a plurality of replaceable polishing stones having complex stone geometries. Rigid stone holders may be better for vertical surfaces or for access to smaller surfaces.

In another embodiment, the stone holder may comprise a flexible stone holder for simple geometries. The flexible stone holder may be configured to manipulate one of a plurality of replaceable polishing stones having simple stone geometries. A flexible stone holder, such as a sponge, may be better for horizontal surfaces or beneficial for large surfaces.

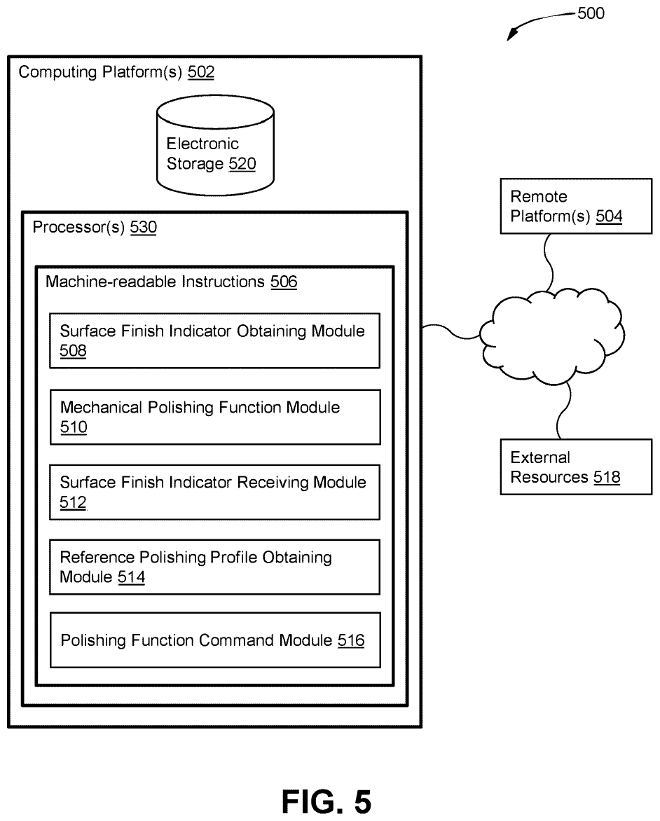

FIG. 5 illustrates a system 500 configured for mechanical polishing, in accordance with one or more embodiments, for example mechanical polishing of a surface of a manufacturing mold. In some embodiments, system 500 may include one or more computing platforms 502. Computing platform(s) 502 may be configured to communicate with one or more remote platforms 504 according to a client/server architecture, a peer-to-peer architecture, and/or other architectures. Remote platform(s) 504 may be configured to communicate with other remote platforms via computing platform(s) 502 and/or according to a client/server architecture, a peer-to-peer architecture, and/or other architectures. Users may access system 500 via remote platform(s) 504.

Computing platform(s) 502 may be configured by machine-readable instructions 506. Machine-readable instructions 506 may include one or more instruction modules. The instruction modules may include computer program modules. The instruction modules may include one or more of surface finish indicator obtaining module 508, mechanical polishing function module 510, surface finish indicator receiving module 512, reference polishing profile obtaining module 514, polishing function command module 516, and/or other instruction modules.

Surface finish indicator obtaining module 508 may be configured to obtain, for example by a verification apparatus, a surface finish indicator associated with the surface of the manufacturing mold to be polished.

Mechanical polishing function module 510 may be configured to provide instructions to perform, for example by a polishing robot, a mechanical polishing function on the surface. The mechanical polishing function may remove material from the surface, as opposed to buffing. Mechanical polishing function module 510 may be configured to provide instructions associated with performing the mechanical polishing function, for example without actually performing the polishing function by or using the module 510.

Surface finish indicator receiving module 512 may be configured to receive, for example by a controller and from the verification apparatus, the surface finish indicator.

Reference polishing profile obtaining module 514 may be configured to obtain, for example by the controller, a reference polishing profile for the surface.

Polishing function command module 516 may be configured to send, for example by the controller and to the polishing robot, a command to perform the polishing function on the surface based on the obtained surface finish indicator and the reference polishing profile.

In some embodiments, computing platform(s) 502, remote platform(s) 504, and/or external resources 518 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 502, remote platform(s) 504, and/or external resources 518 may be operatively linked via some other communication media.

A given remote platform 504 may include one or more processors configured to execute computer program modules. The computer program modules may be configured to enable an expert or user associated with the given remote platform 504 to interface with system 500 and/or external resources 518, and/or provide other functionality attributed herein to remote platform(s) 504. By way of non-limiting example, a given remote platform 504 and/or a given computing platform 502 may include one or more of a server, a desktop computer, a laptop computer, a handheld computer, a tablet computing platform, a NetBook, a Smartphone, a gaming console, and/or other computing platforms.

External resources 518 may include sources of information outside of system 500, external entities participating with system 500, and/or other resources. In some embodiments, some or all of the functionality attributed herein to external resources 518 may be provided by resources included in system 500.

Computing platform(s) 502 may include electronic storage 520, one or more processors 530, and/or other components. Computing platform(s) 502 may include communication lines, or ports to enable the exchange of information with a network and/or other computing platforms. Illustration of computing platform(s) 502 in FIG. 5 is not intended to be limiting. Computing platform(s) 205 may include a plurality of hardware, software, and/or firmware components operating together to provide the functionality attributed herein to computing platform(s) 502. For example, computing platform(s) 502 may be implemented by a cloud of computing platforms operating together as computing platform(s) 502.

Electronic storage 520 may comprise non-transitory storage media that electronically stores information. The electronic storage media of electronic storage 520 may include one or both of system storage that is provided integrally (i.e., substantially non-removable) with computing platform(s) 502 and/or removable storage that is removably connectable to computing platform(s) 502 via, for example, a port (e.g., a USB port, a firewire port, etc.) or a drive (e.g., a disk drive, etc.). Electronic storage 520 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 520 may include one or more virtual storage resources (e.g., cloud storage, a virtual private network, and/or other virtual storage resources). Electronic storage 520 may store software algorithms, information determined by processor(s) 530, information received from computing platform(s) 502, information received from remote platform(s) 504, and/or other information that enables computing platform(s) 502 to function as described herein.

Processor(s) 530 may be configured to provide information processing capabilities in computing platform(s) 502. As such, processor(s) 530 may include one or more of a digital processor, an analog processor, a digital circuit designed to process information, an analog circuit designed to process information, a state machine, and/or other mechanisms for electronically processing information. Although processor(s) 530 is shown in FIG. 5 as a single entity, this is for illustrative purposes only. In some embodiments, processor(s) 530 may include a plurality of processing units. These processing units may be physically located within the same device, or processor(s) 530 may represent processing functionality of a plurality of devices operating in coordination. Processor(s) 530 may be configured to execute modules 508, 510, 512, 514, and/or 516, and/or other modules. Processor(s) 530 may be configured to execute modules 508, 510, 512, 514, and/or 516, and/or other modules by software; hardware; firmware; some combination of software, hardware, and/or firmware; and/or other mechanisms for configuring processing capabilities on processor(s) 530. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 508, 510, 512, 514, and/or 516 are illustrated in FIG. 5 as being implemented within a single processing unit, in embodiments in which processor(s) 530 includes multiple processing units, one or more of modules 508, 510, 512, 514, and/or 516 may be implemented remotely from the other modules. The description of the functionality provided by the different modules 508, 510, 512, 514, and/or 516 described below is for illustrative purposes, and is not intended to be limiting, as any of 508, 510, 512, 514, and/or 516 may provide more or less functionality than is described. For example, one or more of modules 508, 510, 512, 514, and/or 516 may be eliminated, and some or all of its functionality may be provided by other ones of modules 508, 510, 512, 514, and/or 516. As another example, processor(s) 530 may be configured to execute one or more additional modules that may perform some or all of the functionality attributed below to one of modules 508, 510, 512, 514, and/or 516.

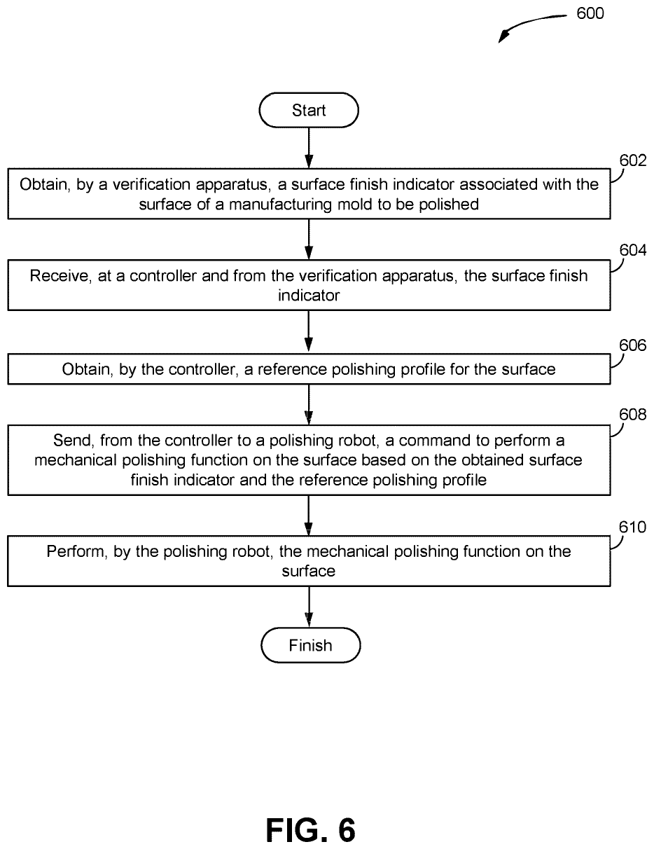

FIG. 6 illustrates a method 600 for mechanical polishing, or for coordinating or instructing mechanical polishing, in accordance with one or more embodiments. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting.

In some embodiments, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 600.

An operation 602 may include obtaining, for example by a verification apparatus, a surface finish indicator associated with the surface of the manufacturing mold to be polished. Operation 602 may be performed by one or more hardware processors configured by machine-readable instructions including a module that is the same as or similar to surface finish indicator obtaining module 508, in accordance with one or more embodiments.

An operation 604 may include receiving, for example by a controller and from the verification apparatus, the surface finish indicator. Operation 604 may be performed by one or more hardware processors configured by machine-readable instructions including a module that is the same as or similar to surface finish indicator receiving module, in accordance with one or more embodiments.

An operation 606 may include obtaining, for example by the controller, a reference polishing profile for the surface. Operation 606 may be performed by one or more hardware processors configured by machine-readable instructions including a module that is the same as or similar to reference polishing profile obtaining module 514, in accordance with one or more embodiments.

An operation 608 may include sending, for example by the controller and to a polishing robot, a command to perform a mechanical polishing function on the surface based on the obtained surface finish indicator and the reference polishing profile. Operation 608 may be performed by one or more hardware processors configured by machine-readable instructions including a module that is the same as or similar to polishing function command module 516, in accordance with one or more embodiments.

An operation 610 may include performing, for example by the polishing robot, the mechanical polishing function on the surface, the mechanical polishing function removing material from the surface. Operation 610 may be performed by one or more hardware processors configured by machine-readable instructions including a module that is the same as or similar to mechanical polishing function module 510, in accordance with one or more embodiments. In an embodiment, the method may omit the operation 610, when the method is being performed by a system that is in communication with, but does not itself comprise, the polishing robot.

In an example embodiment, and in relation to FIG. 5 and FIG. 6, the present disclosure provides a non-transient computer-readable storage medium having instructions embodied thereon. The instructions may be executable by one or more processors to perform a computer-implemented method for mechanical polishing of a surface of a manufacturing mold. The method may comprise: obtaining, by a verification apparatus, a surface finish indicator associated with the surface of the manufacturing mold to be polished; performing or instructing performance of, by a polishing robot, a mechanical polishing function on the surface, the mechanical polishing function removing material from the surface; receiving, by a controller and from the verification apparatus, the surface finish indicator; obtaining, by the controller, a reference polishing profile for the surface; and sending, by the controller and to the polishing robot, a command to perform the polishing function on the surface based on the obtained surface finish indicator and the reference polishing profile.

Embodiments of the present disclosure provide a system and method for mechanical polishing. While embodiments have been described in detail in relation to a manufacturing mold and a polishing robot, other example embodiments may be applied to any number of types of surfaces to be polished, and may include other types of polishing apparatus.

In an aspect, the present disclosure provides a system for mechanical polishing. The system may comprise a verification apparatus configured to obtain a surface finish indicator associated with the surface to be polished. The system may comprise, or may alternatively be in communication with, a polishing apparatus configured to perform a mechanical polishing function on the surface. The system may comprise a controller. The controller may be configured to receive, from the verification apparatus, the surface finish indicator. The controller may be configured to obtain a reference polishing profile for the surface. In another embodiment, the system may perform the mechanical polishing without obtaining a reference polishing profile. The controller may be configured to send, to the polishing apparatus, a command to perform the polishing function on the surface based on the obtained surface finish indicator, and optionally also based on the reference polishing profile.

In another aspect, the present disclosure provides a method for mechanical polishing of a surface, comprising: obtaining, by a verification apparatus, a surface finish indicator associated with the surface to be polished; performing or instructing performance of, by a polishing apparatus, a mechanical polishing function on the surface; receiving, by a controller and from the verification apparatus, the surface finish indicator; obtaining, by the controller, a reference polishing profile for the surface; and sending, by the controller and to the polishing apparatus, a command to perform the polishing function on the surface based on the obtained surface finish indicator and the reference polishing profile.

In a further aspect, the present disclosure provides a method for mechanical polishing of a surface, comprising: obtaining a surface finish indicator associated with the surface to be polished; performing or instructing performance of a mechanical polishing function on the surface; receiving the surface finish indicator; obtaining a reference polishing profile for the surface; and sending a command to perform the polishing function on the surface based on the obtained surface finish indicator and the reference polishing profile.

In a yet further aspect, the present disclosure provides a non-transient computer-readable storage medium having instructions embodied thereon. The instructions may be executable by one or more processors to perform a computer-implemented method for mechanical polishing of a surface of a manufacturing mold. The method may comprise: obtaining, by a verification apparatus, a surface finish indicator associated with the surface to be polished; performing or instructing performance of, by a polishing apparatus, a mechanical polishing function on the surface; receiving, by a controller and from the verification apparatus, the surface finish indicator; obtaining, by the controller, a reference polishing profile for the surface; and sending, by the controller and to the polishing apparatus, a command to perform the polishing function on the surface based on the obtained surface finish indicator and the reference polishing profile.

In another aspect, the present disclosure provides a method for mechanical polishing of a surface, comprising: obtaining a surface finish indicator associated with the surface to be polished; obtaining a reference polishing profile for the surface; sending a command to perform a mechanical polishing function on the surface based on the obtained surface finish indicator and the reference polishing profile; and optionally performing the mechanical polishing function on the surface.

In a further aspect, the present disclosure provides a system for coordinating mechanical polishing of a surface of a manufacturing mold, comprising: a verification apparatus configured to obtain a surface finish indicator associated with the surface of the manufacturing mold to be polished; and a controller configured to: receive, from the verification apparatus, the surface finish indicator, obtain a reference polishing profile for the surface, and send, to a polishing robot, a command to perform a mechanical polishing function on the surface based on the obtained surface finish indicator and the reference polishing profile, the mechanical polishing function configured to remove material from the surface.

In a yet further aspect, the present disclosure provides a method for coordinating mechanical polishing of a surface of a manufacturing mold, comprising: obtaining, by a verification apparatus, a surface finish indicator associated with the surface of the manufacturing mold to be polished; receiving, by a controller and from the verification apparatus, the surface finish indicator; obtaining, by the controller, a reference polishing profile for the surface; sending, by the controller and to the polishing apparatus, a command to perform a mechanical polishing function on the surface based on the obtained surface finish indicator and the reference polishing profile, the mechanical polishing function configured to remove material from the surface.

In a still further aspect, the present disclosure provides a non-transient computer-readable storage medium having instructions embodied thereon, the instructions being executable by one or more processors to perform a computer-implemented method for coordinating mechanical polishing of a surface of a manufacturing mold, the method comprising: obtaining, by a verification apparatus, a surface finish indicator associated with the surface of the manufacturing mold to be polished; receiving, by a controller and from the verification apparatus, the surface finish indicator; obtaining, by the controller, a reference polishing profile for the surface; sending, by the controller and to the polishing apparatus, a command to perform a mechanical polishing function on the surface based on the obtained surface finish indicator and the reference polishing profile, the mechanical polishing function configured to remove material from the surface.

In another aspect, the present disclosure provides a system for coordinating mechanical polishing of a surface, comprising: a verification apparatus configured to obtain a surface finish indicator associated with the surface to be polished; and a controller configured to: receive, from the verification apparatus, the surface finish indicator, obtain a reference polishing profile for the surface, and send, to a polishing robot, a command to perform a mechanical polishing function on the surface based on the obtained surface finish indicator and the reference polishing profile, the mechanical polishing function configured to remove material from the surface.

In a further aspect, the present disclosure provides a method for coordinating mechanical polishing of a surface, comprising: obtaining, by a verification apparatus, a surface finish indicator associated with the surface to be polished; receiving, by a controller and from the verification apparatus, the surface finish indicator; obtaining, by the controller, a reference polishing profile for the surface; sending, by the controller and to the polishing apparatus, a command to perform a mechanical polishing function on the surface based on the obtained surface finish indicator and the reference polishing profile, the mechanical polishing function configured to remove material from the surface.

In a yet further aspect, the present disclosure provides a non-transient computer-readable storage medium having instructions embodied thereon, the instructions being executable by one or more processors to perform a computer-implemented method for coordinating mechanical polishing of a surface, the method comprising: obtaining, by a verification apparatus, a surface finish indicator associated with the surface to be polished; receiving, by a controller and from the verification apparatus, the surface finish indicator; obtaining, by the controller, a reference polishing profile for the surface; sending, by the controller and to the polishing apparatus, a command to perform a mechanical polishing function on the surface based on the obtained surface finish indicator and the reference polishing profile, the mechanical polishing function configured to remove material from the surface.

Embodiments of the present disclosure may comprise a reciprocating mechanism to polish surfaces. Embodiments of the present disclosure may comprise specialized methods, including machine learning or artificial intelligence, to generate polishing paths or to identify the areas to polish. Embodiments of the present disclosure may comprise a manufacturing cell comprising multiple polishing setups. Embodiments of the present disclosure may comprise a quality system to verify the quality of polishing accomplished by the polishing setup. Embodiments of the present disclosure may polish one mold or multiple molds at one time, or have multiple robots configured to polish one mold. Embodiments of the present disclosure may comprise a multiple robot axis configuration, for example from 6 to 10 axis.

Embodiments of the present disclosure may perform, or instruct performance of, a polishing function based on polish types including stone, paper, diamond buff. Embodiments of the present disclosure may be fixed at one location as a cell, or one unit may be portable. Embodiments of the present disclosure may be configured to permit input of design data, such as computer aided design (CAD) data, and to utilize the inputted design data directly to control the polishing robot(s). Embodiments of the present disclosure may be configured to recognize a “go” or “no go” on the quality of the surface finish, and to generate an alert when a “no go”.

Embodiments of the present disclosure may comprise a camera vision system configured to capture images and to compare the captured images to a standard for quality checks. Embodiments of the present disclosure may comprise one or more optional attachments, such as a camera, polishing holder, reciprocating holder, or standard polishing tools. Embodiments of the present disclosure may be configured to be mounted to the floor or to be hung from a ceiling or structure. Embodiments of the present disclosure may store captured data for future reference and comparison to standards.

Embodiments of the present disclosure may provide increased production speed, reduced repetitive injuries, and automated polishing, in a way that is less labor intensive and reduces dependence on highly skilled labor.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

1. A system for mechanical polishing of a surface of a manufacturing mold, comprising:
a verification apparatus configured to obtain a surface finish indicator associated with the surface of the manufacturing mold to be polished;
a polishing robot configured to perform a mechanical polishing function on the surface, the mechanical polishing function for removing material from the surface; and
a controller configured to:
receive, from the verification apparatus, the surface finish indicator,
obtain a reference polishing profile for the surface, and
send, to the polishing robot, a command to perform the polishing function on the surface based on the obtained surface finish indicator and the reference polishing profile.

2. The system of claim 1 wherein the verification apparatus comprises a vision system including at least one camera, and wherein the surface finish indicator comprises an image of the surface.

3. The system of claim 1 wherein the verification apparatus comprises a sensor and wherein the surface finish indicator comprises data associated with a measured finish quality of the surface.

4. The system of claim 3 wherein the controller is configured to cooperate with the verification apparatus to determine a surface finish level based on the obtained data associated with the measured finish quality of the surface.

5. The system of claim 1 wherein the polishing robot comprises an end effector configured to manipulate a polishing tool.

6. The system of claim 5 wherein the end effector comprises a stone holder configured to manipulate a polishing stone to perform the polishing function on the surface.

7-8. (canceled)

9. The system of claim 1 wherein the controller is configured send the command based on a comparison between the obtained surface finish indicator and the reference polishing profile.

10. The system of claim 9 wherein the controller is configured to:
compare, using a machine learning-based comparator, the obtained surface finish indicator with the reference polishing profile; and
generate the command based at least in part on a result of the comparison using the machine learning-based comparator.

11. The system of claim 1 wherein:
the controller is configured to send the command to perform the polishing function based on a specified surface finish parameter; and
the polishing robot is configured to perform the polishing function on the surface such that, after the polishing function has been completed, the surface complies with the specified surface finish parameter.

12-17. (canceled)

18. The system of claim 1 wherein:
the controller is configured to send first and second commands to perform first and second polishing functions based on a first surface finish parameter and a second surface finish parameter, respectively, the second surface finish parameter being associated with a higher polish than the first surface finish parameter; and
the polishing robot is configured to perform the first polishing function such that, after the first polishing function has been completed, the surface complies with the first surface finish parameter, and to subsequently perform the second polishing function such that, after the second polishing function has been completed, the surface complies with the second surface finish parameter.

19. The system of claim 18 wherein:
the controller is configured to:
receive a first polishing completion indication from the polishing robot upon completion of the first polishing function; and
prevent the polishing robot from performing the second polishing function until the first polishing completion indication has been received.

20. The system of claim 1 wherein:
the verification apparatus is configured to obtain first and second surface finish indicators providing respective indications of a measured finish quality of first and second areas of the surface to be polished;
the polishing robot is configured to perform first and second polishing functions on the first and second areas of the surface, respectively; and
the controller is configured to:
receive, from the verification apparatus, the first and second surface finish indicators,
send, to the polishing robot, a first command to perform the first polishing function on the first area of the surface based on the first surface finish indicator, and
send, to the polishing robot, a second command to perform the second polishing function on the second area of the surface based on the second surface finish indicator.

21. The system of claim 1 wherein the polishing robot comprises a plurality of polishing robots.

22. The system of claim 21 wherein:
the plurality of polishing robots are configured to perform a plurality of polishing functions on the surface; and
the controller is configured to:
receive, from the verification apparatus, the surface finish indicator, and
send, to the plurality of polishing robots, a plurality of commands to cooperate to perform the plurality of polishing functions on the surface based on the surface finish indicator.

23. The system of claim 21 wherein:
the verification apparatus is configured to obtain a plurality of surface finish indicators providing respective indications of a measured finish quality of a plurality of areas of the surface to be polished;
the plurality of polishing robots are configured to perform a plurality of polishing functions on the plurality of areas of the surface; and
the controller is configured to:
receive, from the verification apparatus, the plurality of surface finish indicators,
send, to the plurality of polishing robots, a plurality of commands to perform the plurality of polishing functions on the plurality of areas of the surface based on the plurality of surface finish indicators.

24. The system of claim 23 wherein the plurality of polishing robots comprises a first set of polishing robots and a second set of polishing robots, and wherein:
the first and second sets of polishing robots are configured to substantially concurrently perform first and second polishing functions, respectively, on the same area of the surface; and
the controller is configured to:
send, to the first and second sets of polishing robots, first and second sets of commands to perform the first and second functions, respectively, on the same area of the surface.

25. The system of claim 23 wherein the plurality of polishing robots comprises a first set of polishing robots and a second set of polishing robots, and wherein:
the first and second sets of polishing robots are configured to perform first and second polishing functions substantially sequentially on the same area of the surface; and
the controller is configured to:
send, to the first and second sets of polishing robots, first and second sets of commands to perform the first and second functions, respectively, on the same area of the surface.

26. The system of claim 23 wherein the plurality of polishing robots comprises a first set of polishing robots and a second set of polishing robots, and wherein:
the first and second sets of polishing robots are configured to substantially concurrently perform first and second polishing functions on first and second areas of the surface, respectively; and
the controller is configured to:
send, to the first and second sets of polishing robots, first and second sets of commands to perform the first and second functions, respectively, on the first and second areas of the surface.

27. (canceled)

28. A method for mechanical polishing of a surface of a manufacturing mold, comprising:
obtaining, by a verification apparatus, a surface finish indicator associated with the surface of the manufacturing mold to be polished;
receiving, by a controller and from the verification apparatus, the surface finish indicator;
obtaining, by the controller, a reference polishing profile for the surface; and
sending, by the controller and to a polishing robot, a command to perform the polishing function on the surface based on the obtained surface finish indicator and the reference polishing profile; and
performing, by the polishing robot, a mechanical polishing function on the surface, the mechanical polishing function removing material from the surface.

29. A non-transient computer-readable storage medium having instructions embodied thereon, the instructions being executable by one or more processors to perform a computer-implemented method for mechanical polishing of a surface of a manufacturing mold, the method comprising:
obtaining, by a verification apparatus, a surface finish indicator associated with the surface of the manufacturing mold to be polished;
receiving, by a controller and from the verification apparatus, the surface finish indicator;
obtaining, by the controller, a reference polishing profile for the surface;
sending, by the controller and to a polishing robot, a command to perform the polishing function on the surface based on the obtained surface finish indicator and the reference polishing profile; and
performing, by the polishing robot, a mechanical polishing function on the surface, the mechanical polishing function removing material from the surface.

30-38. (canceled)
